(19) United States
(12) Patent Application Publication
(10) Pub. No.: US 2017/0196749 A1
(43) Pub. Date: Jul. 13, 2017

(54) Pivotal Edge Hand Table

(71) Applicant: Robert S. Hatch, Ormond Beach, FL (US)

(72) Inventor: Robert S. Hatch, Ormond Beach, FL (US)

(21) Appl. No.: 14/991,456

(22) Filed: Jan. 8, 2016

(51) Int. Cl. A61G 13/12; F16M 11/14

(52) U.S. Cl. CPC A61G 13/124; F16M 11/14

(57) ABSTRACT

An apparatus comprising as upper plate mounted on a pillar with pivotal means for motion is placed close to the axes of wrist action. By this construct a wide range of wrist positional opportunities is realized without producing unwanted elbow motion in a longitudinal or vertical plane. The practitioner enjoys ample access to the anatomy while being unburdened from repositioning the upper extremity due to unwanted shifts of the elbow and the shoulder. The hand and digits are secured to the upper plate. All materials of the apparatus are made from available stout material able to support the well-positioned upper extremity. A specialized positioning technique with guidelines for verification of proper apparatus utilization further separates the apparatus from the prior art.

This application claims the benefit of priority to U.S. Provisional Patent Application No. 62/101,754 filed Jan. 9, 2015.

### FIELD OF INVENTION

This invention relates to a positioning apparatus of the hand and wrist for contemporary-styled medical procedures and for other uses where positioning, holding and repositioning the hand and wrist are part of a method.

### BACKGROUND AND PRIOR ART

The properly positioned hand and wrist allows a practitioner to work on the anatomy from a desired perspective. Repositioning, or the ability to move the hand and wrist through a range of motion from an initial position, is as important. Hand and wrist positioning technology has been relatively stagnant in comparison to the trend of increasingly sophisticated wrist and hand procedures. These more exacting procedures stand in need of devices that improve efficiency through efficient anatomy placement.

Advances in ultrasound guided therapeutic procedures exemplify contemporary demands for access to a discrete portion of anatomy. A practitioner can take years to master an approach. A device enhancing the established procedure would be an attractive option for the practitioner. Failure of many positioning devices to capture market share may reflect the inflexibility of the device to accommodate a practitioner's preference to perform a procedure by their accustomed approach.

The most widely used commercial hand and wrist support devices are simple concepts such as the ironing board shaped “upper extremity table”. These devices permit physicians to position the extremity in a rudimentary way and then finalize positioning using the standard operating room positioning props such as blocks, towels, gel pads, gauze, human assistants and more. While seemingly outdated, these common operating room habitudes have proven successful in allowing practitioners to customize approaches for positioning and repositioning. Failure of the prior art to replace these practices reflects design flaws that generally do not enhance efficiency, speed or accuracy of procedural tasks. The role of a hand-wrist positioning device must then be clearly understood before offering advantages over the prior art and practices.

Pivoting hand tables have been suggested as an intuitive remedy to ordinary positioning applications, but unimpressive marketplace reception questions their real world utility. Critical design flaws hinder these products and the prior art seems uninterested in correlating pivoting styled hand tables with upper extremity biomechanics. Prior inventions suggest that simply pivoting a hand is enough to improve procedural efficiency. Thus, prior inventions have not recognized unique applications of pivoting plate technology that can dramatically affect performance of a product.

Practitioners utilizing hand and wrist positioning devices move a wrist either by wrist-action, wrist-movement or some combination of the two. Wrist action is a change in the alignment of the wrist (carpal) bones in contrast to general wrist movement which also includes passive motion through space such as can occur when elbow action moves a fused (immobile) wrist through space. Reproducing wrist-action requires a general understanding of wrist kinetics.

The center for rotational axis of flexion and extension actions of the wrist lies at the capitate bone in the mid wrist region. Both flexion and extension (in the sagittal plane) of the wrist with a starting position of the wrist lying straight along the longitudinal axis of the forearm is approximately 90 degrees (each). Pronation and supination actions of the wrist are produced by forearm rotation and both directions can approximate 90 degrees. Radial and ulna deviation complete the range of wrist action with radial deviation approximately 20 degrees and ulna deviation approximately 30 degrees. All of the above motion ranges can vary between individuals.

A hand-wrist positioning device, in proper light, must be evaluated by the range of motion offered, the ease in attaining a helpful initial position and the efficiency of the apparatus in moving the anatomy from one position to another.

A review of specific published relevant prior art is presented:

U.S. Pat. No. 4,564,180 A: Hand holding apparatus for hand surgery.

This apparatus was designed to place a patient's hand upon an upper plate which moves relative to a lower plate. The invention is offered as a composite of these plates plus the ability to lock the plate in any fixed position. The apparatus has “a pair of surface defining devices” for additional positioning options. The method of pivotally moving the upper plate relative to the lower plate is not discussed with this invention nor are the desired mechanics of the pivotal movement with respect to the hand or to the upper table. Similarly there is no discussion of the general principals of wrist-hand mechanics or concepts of complementary pivoting technologies (options) that maximize hand-wrist motion. Patent images suggest a substantially central position of the ball and socket pivoting mechanism relative to the upper and lower plates. Of great importance are the independent claims which, again, present the invention as a composite not to exclude a specially adapted upper plate, means for locking the pivoting mechanism and means for presenting a linger support. While the apparatus generally succeeds in its attempt to simplify the structure of a hand-holding apparatus, the invention as presented does not offer insight into the range of positioning opportunities provided by its new technology or the advantages thereof. The general statement made in the claims that the pivoting mechanism can be placed at “any one of a number of operational positions . . . ” instructs that there is no preferable position.

From this invention it can be reasonably concluded that the process of hand movement depends upon contributions of motion from the shoulder, elbow, forearm, and wrist. The concept of a stationary shoulder and elbow upper extremity being an advantage while using a hand table is not presented.

U.S. Pat. No. 4,807,864 A: Hand surgery table.

This invention with publication date Feb. 28, 1989, discusses a hand surgery table, an upper surface that moves relative to a base platform, locking means for the mounting/pivoting mechanism and means for support and positioning of the fingers. While the apparatus purports to address the suboptimal positions available with the prior art, the invention as described does not discuss or relate to, in written word, the mechanics by which hand positions are precisely obtained. Drawings of the apparatus show its ability to tilt and pivot making a possible erroneous leap to imply that a hand-wrist would have the same motion if placed upon it. Since the patent images depict the ball and socket mechanism again in a central position, similar to the Agee invention, then the device cannot perform “isolated” wrist movements beyond perhaps 20 degrees, thus introducing the same inefficiencies as the Agee table. A hand lying in a substantially straight position is depicted in one drawing which does not reveal improvements in positional opportunities over the prior art.

Both the Agee and Young inventions include an upper plate, a lower base plate and a pillar mechanism with means for rotation of the upper plate relative to the lower plate. The inventions differ by the architecture of the upper plate. Both appear to favor a ball and socket pivoting mechanism. The upper plate of the Agee invention serves to extend the upper plate and provide digital support in this way. The upper plate of the Young invention demonstrates pillars for placement of the digits.

Failure of these contemporary ball-and-socket hand table concepts to capture significant market share may be that the same positioning problems occur whether the tables are used or not. In other words, the current tables in practice may not actually lessen the use of props and assistants appreciably. The centralized ball and socket design of the prior art inadequately reproduces natural motions of the wrist which then necessitates the use of props to overcome the positioning difficulties, and possibly with the added nuisance of the hand table itself, as an obstacle.

U.S. Pat. No. 5,730,152 A: Surgical limb support and positioning structure: Theodor Esser. The Esser invention addressed the need for wrist positions for contemporary (circa 1996) wrist surgeries not to exclude arthroscopy for carpal tunnel syndrome. An adjustable stand comprised chiefly of two support elements (structures) which could variably be positioned and adjusted otherwise to support the hand, wrist, and forearm. A primary objective of this invention appears to place the junction of the forearm and hand (the wrist) at the junction of the two elements in order to maximize and otherwise adjust for wrist positions in flexion and extension primarily. The device appears to address a narrow scope of still popular procedures.

U.S. Pat. No. 5,813,977 A: Surgical hand support apparatus: Peter Hinchliffe, publication date Sep. 29, 1998.

This invention oilers a support base with attachment for the purpose of positioning the hand and digits for carpal tunnel surgeries and with a specific action of stretching the carpal tunnel ligament. The hand support structure does not pivot. The precise method for positioning the hand on the apparatus is generally included.

The most widely used types of hand tables and armboards are simply flat structures to place the upper extremity upon. This concept is seen in the following patents: US 20030192122 A1, universal hand surgery table; U.S. Pat. No. 4,054,282 A, auxiliary operating table for hand surgery and the like; U.S. Pat. No. 4,082,257 A, surgery table; U.S. Pat. No. 5,287,575 A, hand table: U.S. Pat. No. 6,195,820 B1, pivoting hand table; U.S. Pat. No. 5,758,374 A, portable table assembly; U.S. Pat. No. 5,135,210 A, surgical armboard attachment device. While these inventions are not within the domain of precise hand and wrist positioners they do represent an opinion, as stated by the market place, that such imprecise structures are still frequently desired over the more precise structures.

U.S. Pat. No. 3,540,719 presents an arm board that adjusts only in the vertical plane (ie about a horizontal axis) as is stated in the text “ . . . The articulated arm board itself is mounted to the support bracket for pivotal adjustment about a horizontal axis . . . . The hand supporting portion of the board is articulated to the forearm support. This adjustment also is about a horizontal axis, permitting adjustment of the hand to various positions in a vertical plane about said axis . . . ”. The articulated wrist attachment, however, does position the distal forearm at the junctions of the independent pieces such that isolated wrist motion occurs, but only in one plane. Further more, this device is designed to function only with the hand in a “palm-up” position.

Pivotal plate motion as a vehicle for hand-wrist positions demonstrates an array of affects on the hand-wrist as well as the more proximal anatomy depending on the location of the pivoting point on the table. A simple example of this motion utilizes a single ball and socket joint attached to an upper plate. Observations from this experiment are based on the junction of the wrist and the forearm placed at an edge of the table called the “pivotal edge”. These observations are as follows:

A first observation is that the plate maintains a generally excellent range of rotary motion with resultant flexion, extension, radial deviation, ulna deviation, pronation, supination, and combinations of these motions for positioning of the hand regardless of where the ball and socket is placed at a surface of the plate.

A second observation is that the further the ball and socket lies from the pivotal edge of the table (ie the closer the ball-and-socket comes to the finger tips) the resultant wrist motion dramatically increases in a vertical and longitudinal direction. This undesirable motion requires (obligatory) movement of the elbow proportional to the distance of the ball and socket rotational axis from the wrist, and also proportional to the distance traveled by the pivotal edge of the plate. If the pivotal edge of the plate (ie. the portion of the upper support plate that supports the wrist) moves far enough the elbow would either be lifted from its support (ie with plate-flexion) or pressed into its support (ie with plate-extension) requiring reposition of the elbow. Repositioning of the elbow and shoulder is an unwanted inefficiency during a hand or wrist procedure where there is need for repositioning of only the hand-wrist.

A third observation is that forearm rotation is the only desirable forearm (and elbow) motion. A full range of hand pronation and supination mostly through forearm rotation is achieved with the ball and socket at any position on the table but as the ball and socket are placed further towards the lateral borders of the table there is greater distance traveled by the wrist in pronation and supination.

A fourth observation is that if the forearm is positioned on the same platform as the wrist then pronation and supination remain unaffected but flexion and extension of the hand must then be produced by undesirable elbow movement as the forearm becomes blocks flexion-extension action by the wrist.

A fifth observation is that obligatory elbow movement obligates the forearm, humerus (brachial region) and shoulder to move. Excessive longitudinal elbow movement causes the upper extremity to drag across the support table and this requires a repositioning maneuver of the entire upper extremity. Excessive lift of the elbow requires repositioning due to the weight of the extremity pulling down on the procedural region of the hand and wrist.

A sixth observation is that radial and ulna deviation are affected by ball and socket position such that the further the ball and socket lies from the pivotal edge of the table the loss motion is allowed in both directions. Due to the relatively limited range of motion of radial and ulna deviation in a normal wrist gains and losses in motion are less noticeable than with flexion-extension and pronation-supination. Furthermore, on a true pivoting table lost pronation and supination can be compensated for by table tilt.

A seventh observation concerns the limitations of a ball, stem and socket mechanism and its effects on the movement of the closest edge of the plate to the mechanism (ie pivotal edge). Rotation in any plane causes longitudinal and vertical plane displacements of the plate no matter the size of the ball. These effects can be minimized by placing the ball and stem as close to the pivotal edge as possible, reducing the size of the ball and shortening the stem. All of these adjustments can decrease the strength of the load bearing properties of the apparatus.

An eighth observation recognizes the utility of a plurality of pivotal mechanisms coordinating movement of the plate. Two independently moveable ball and socket mechanisms would produce more accurate motion than a one-ball system. The trade-off would then be in the complexity of the process of coordinating the motion and of locking each independent mechanism. A similar argument can be used for a three-ball and socket system or for a combination of dissimilar but compatible cooperative mobile mechanisms. A mechanically “perfect mechanism” would produce no forward or vertical displacement of the pivotal edge line.

Fortunately, there are tolerances for these displacements by the body. Soft tissue support and pliability about the elbow and upper arm provide up to 3 cm of assisted lift and translation. These soft tissue properties diminish the effects of imperfect ball and socket motion so as to be functionally equivalent to the “perfect mechanism”.

The use of ball-and-socket joints in industry cannot be understated. These simple mechanical devices are relatively easy to manufacture, have low cost and provide a wide range of motion in many applications. The simple ball and socket mechanism as a paradigm for pivotal motion is useful in demonstrating that motion of a supportive plate can be tailored to the required demands by adjustments to the table, the position of the extremity upon the table and the pivoting mechanism.

Knowledge of the function of an apparatus must precede its form, thus, by the above observations, a pivoting hand table with one or more pivoting elements should at least have the following attributes:

The wrist/hand junction should lie at an edge of the platform (pivotal edge) with the rotational axis of the pivotal meats positioned as close to both the same edge and the wrist (as the technology will allow) so that the edge of the table electively mirrors wrist motion.

The hand lies on the upper platform with the junction of the wrist and hand placed at the edge of the table without the forearm encroaching on the upper support plate.

The forearm performs pronation and supination for the hand with minimal contribution from the wrist

The wrist performs flexion and extension for the hand with negligible contribution from the forearm/elbow.

The wrist performs radial and ulna deviation of the hand with negligible contribution from the forearm/elbow.

The pivotal mechanism is placed along a center longitudinal dividing line of the table to minimize changes in table position with corresponding changes in hand positions.

The pivotal edge hand table concept will now be described:

The pivotal edge table mediates wrist action by placing the axis of rotation of an edge (also called the pivotal edge or near edge) of a support plate (the upper support plate) near the rotational axis of the wrist. Xray studies of the plate edge with a well positioned wrist show the pivotal edge positioned at the level of the capitate bone. The presented embodiment is manufactured with a single ball and socket joint. The size of the ball, placement of the ball near the end of the table and the length of the stem have been optimized to produce a substantial increase in range of motion and reproduce natural wrist motion so as not cause significant lift and drag of the elbow. The pillar is attached to a fewer support plate that allows the apparatus to stand independently and bear the weight of an upper extremity.

The juxtaposition of the wrist, pivotal means and the associated end of the plate exposes a previously unrecognized property of a pivotal hand table, that being, that the wrist is capable of rotating the hand in a near full range of motion, in all planes, without additional motion from the remaining portions of the upper extremity with the exception of elbow pronation and supination. Elbow pronation and supination is useful motion for hand and wrist positioning. Elimination of the unnecessary upper extremity movements of the elbow and shoulder eliminates pausing of a procedure solely for repositioning.

Nomenclature for motion of the apparatus (ie the current ball and socket embodiment of the Pivoting Hand Table without a hand upon it) requires spatial perspective. The chosen perspective is with the apparatus in front of an observer, the pivotal edge facing the observer in a proximal position and the upper support plate in a neutral position which is designated as the plate lying parallel to the floor. In this neutral position the center of the pivotal edge lies at zero degrees. When the far end (or distal end) of the plate deflects upward then the upper support plate is in plate-extension. When the far end of the plate deflects downward then the upper plate is in plate-flexion. From neutral position the plate can tilt in a clockwise (right tilt) or counterclockwise (left tilt) direction. Rotation of the plate while in a neutral position is also possible with the plate being able to spin past 360 degrees clockwise and counter clockwise. If, from a neutral position, the far end of the table goes to the right then a clockwise spin has begun and, from a neutral position, if the far end proceeds to the left then a counterclockwise spin has begun.

Ensuring good functioning of the pivotal edge hand table concept and differentiating the apparatus from other concepts and apparatuses is first accomplished by noting the unconventional appearance of the apparatus whereby the pivotal mechanism acts substantially at one end of the plate. Similarly there is an unconventional appearance of the mounted hand upon a table with a support mechanism that may seem unconventional. A second appearance difference is that the pillar is conspicuously elongated to allow for increased clearance for the wide range of wrist motion. A third appearance difference contained within some embodiments would be an array of cooperative independently moveable pivoting elements acting from the pivotal edge.

Quantitative performance guidelines can also differentiate the pivotal edge hand table concept from the prior art.

A first quantitative method is a measure of motion by the pivotal edge (near edge) where the central portion of the wrist lies. The upper plate is moved in plate flexion from 0 degrees to 30 degrees and the near edge should elevate no more than 3 cm vertically.

A second quantitative guideline is to measure elbow motion by movement of the tip of the olecranon, again, through a minimum of a 30 degree flexion-extension arc (from neutral position). The olecranon is a conspicuous and easily identifiable boney landmark even in the obese person. The olecranon should move no more than 3 cm in any direction from an initial starting place despite any actions of the wrist.

A third quantitative guideline is by using the plate flexion (0-30 degrees) maneuver and observing movement of the olecranon as it translates and glides smoothly over its surrounding (and supporting) soft tissues. If the elastic capacity of the tissues to provide smooth motion is reached then the elbow (or upper arm, if the elbow does not contact the supporting table directly) will begin to drag causing an abrupt increase in the force required to move the extremity.

Another difference from the prior art is in the method of use. The pivotal edge hand table requires proper placement of the wrist at the pivotal (near) end of the upper support plate. Positioning of the remainder of the upper extremity follows by determining the desired angle of the forearm for the procedure and then stabilizing the upper extremity sufficiently to secure and balance the apparatus. When final position is obtained a range of motion test is performed to ensure that the wrist and hand move as desired and that there is no need for repositioning.

### SUMMARY Of THE INVENTION

A single ball and socket based embodiment of the pivotal edge hand table demonstrates a novel concept for hand and wrist positioning by creating cooperative movement with the wrist.

While prior art limits hand positioning opportunities by a centralized rotational axis and a short pillar and relies on movement in space of the forearm, elbow and shoulder to produce multi-plane hand motion, the pivotal edge hand table, in contrast, demonstrates the application of a cooperative movement principle that improves range of wrist motion provided by a hand table while eliminating unwanted upper extremity motion.

Improved wrist motion is created by spatially superimposing the rotational axes of the wrist, the pivotal edge of the supporting plate and the pivoting mechanism thus eliminating incompatible motions of the wrist and the plate it rests upon. Efficiency of use is realized by the general improved range of motion, and by the uncoupling of wrist motion from elbow motion in such a way as to avoid repositioning of the elbow during a procedure while adjusting the wrist (and hand) angle on the support plate.

Differentiating the invention from prior art can be done by appearance, by quantitative performance criteria, and by a method for establishing the upper extremity position.

The pivotal edge hand table instructs a new strategy for supporting the hand and wrist by an improved mechanical concept that positions a hand and wrist on an apparatus having highly complementary movement. Further objects and advantages of this invention will be apparent from the following detailed description of the presently preferred embodiments which are illustrated schematically in the accompanying drawings.

### BRIEF DESCRIPTION OF THE FIGURES

FIG. 1 Side view of apparatus with upper support plate in neutral position

FIG. 2 Side view of apparatus with a hand resting on the upper support plate in a neutral position

FIG. 3 Exploded view of the ball and socket mount to the upper support plate and to the pillar

FIG. 4 High angle side view of apparatus with upper support plate in neutral position.

FIG. 5 Front view of apparatus with upper support plate in a degree of left lateral tilt.

FIG. 6 Side view of apparatus with the upper plate in a degree of extension

FIG. 7 Side oblique view of apparatus in a degree of plate-flexion

FIG. 8 High angle side view of apparatus with a hand resting on the upper support plate in a degree of flexion with thumb and digits restrained by ties

FIG. 9A Side view of the apparatus showing a starting position of the well positioned upper extremity

FIG. 9B Side view of the apparatus of FIG. 9A showing a final position of the upper extremity

### DESCRIPTION OF THE PREFERRED EMBODIMENTS

Before explaining the disclosed embodiments of the present invention in detail it is to be understood that the invention is not limited in its applications to the details of the particular arrangements shown since the invention is capable of other embodiments. Also, the terminology used herein is for the purpose of description and not of limitation.

A list of the components used in the figures is defined below.
10. Upper plate.
15. Pivotal edge (Near edge)
20. Upper Plate Notch
30. Hole in upper plate for threaded washer
40. Hole for wrist restraints tie
50. Threaded Washer
60. Ball and threaded stem assembly
70. Socket.
80. Notch in socket
90. Locking mechanism
100. Pillar
110. Pillar support assembly
120. Lower support plate
130. Digital restraint tie

### Detailed Description of the Preferred Embodiments

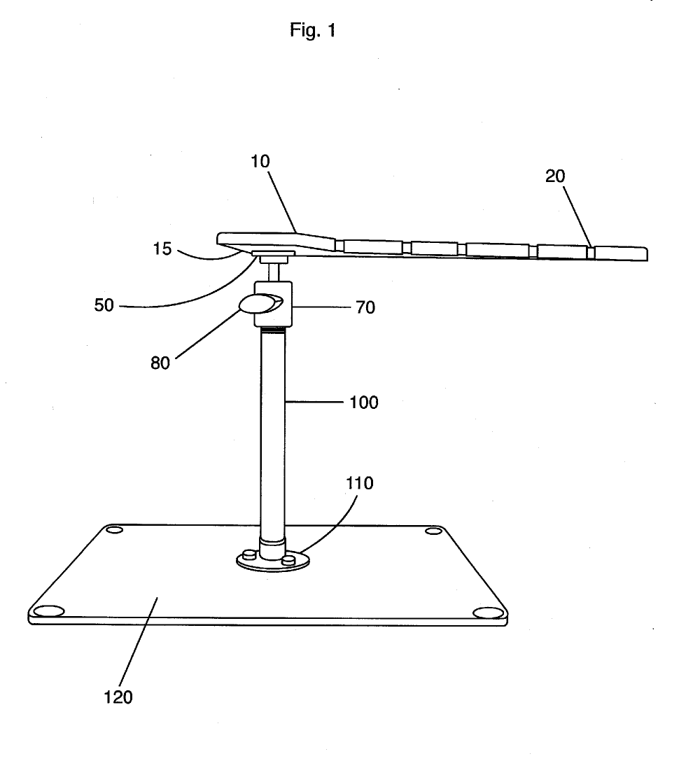

FIG. 1 is a side view of the entire apparatus with upper support plate, 10, in neutral position. In this position the upper support plate lies parallel to the lower support plate. The upper support plate contains upper plate notches, 20, that are cut into the plastic. The upper plate notches, 20, retain digital restraint ties for securing the hand generally or to retain a predetermined array of digits. The pivotal edge, 15, is the proximal extent of the upper support plate and its proximity to a threaded washer, 50, is illustrated. The threaded washer is a mounting means for the upper support plate to receive the ball and stem assembly. The ball is recessed within the socket, 70, and is not seen otherwise. A locking mechanism, 90, provides variable friction to slow or stop rotation of the ball within the socket. The socket is mounted on the pillar, 100. The pillar is attached to to the lower support plate, 120, by a pillar support assembly, 110. A hand can be made to rest on the upper support plate by palm-down or backside-down (dorsum) position and remain in the neutral position or be moved pivotally to another desired position.

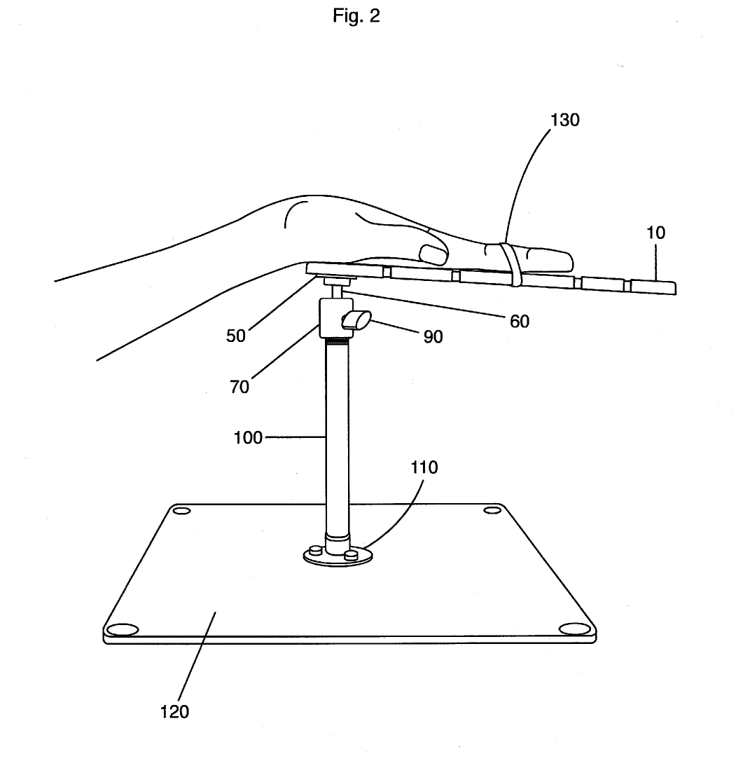

FIG. 2 is a side view of apparatus with a hand-wrist resting on the upper support plate, 10, in a near neutral position similar to the apparatus of FIG. 1. The upper support plate contacts the general area of the wrist and hand without encroachment into the upper plate by the forearm. The anatomy is further supported by the threaded washer, 50, and threaded stem assembly. The socket, 70, is threaded and coupled in this way to the pillar. A locking mechanism, 90, secure the ball which is recessed within the socket. The proximity of the rotational axes of the table near the stem, 60, and of the hand (at the wrist) allows near complete wrist action. This mirroring of motions provides a near complete range of motion for the wrist in flexion, extension, radial deviation, ulna deviation, pronation and supination. The digits are restrained against the upper support plate by a string-like ties, 130, held by notches on the plate. The socket is mounted on the pillar, 100, that then attaches to the lower support plate, 120, by a pillar support assembly.

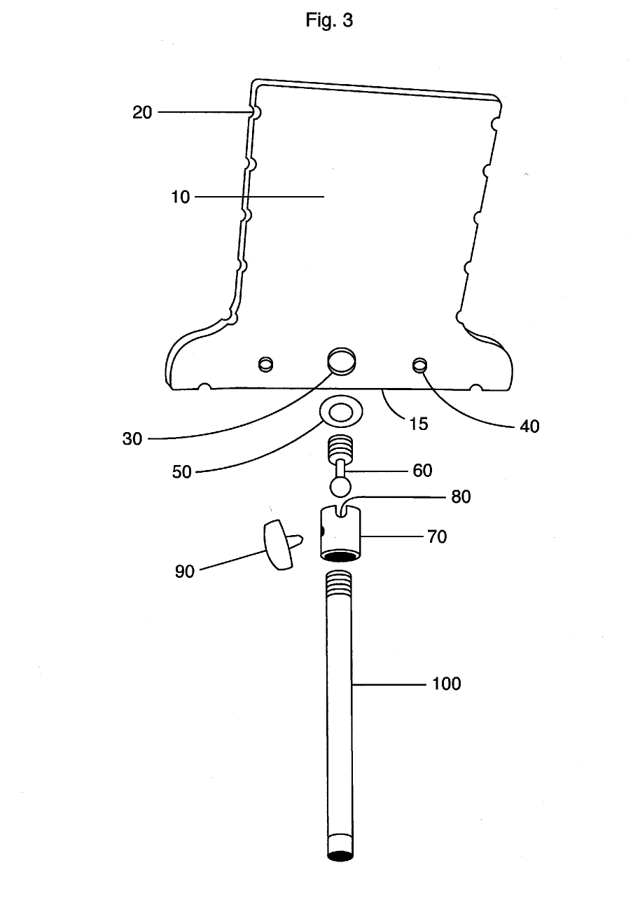

FIG. 3 is a perspective exploded view of the apparatus without the pillar support assembly and the lower support plate. The view clearly shows the pivoting mechanism (the ball-and-socket assembly) eccentrically placed toward an edge of the table (pivotal edge) for the purpose of producing a rotation of axis for the upper plate as close to the same edge as possible. The upper support plate is flat, smooth and is suitable for hand-wrist contact and support. The edges of the upper support plate are lined with notches, 20, that serve to hold digital restraint ties. The proximal end of the upper support plate in this embodiment has a conspicuous expansion of the proximal end of the upper support plate. This proximal expansion is designed for a right or left thumb to be anchored by digital restraint ties. Several small holes for wrist restraint ties, 40, are also located at the proximal end of the upper support plate, 10. The wrist can be secured to the plate in this way if needed. The upper support plate, 10, contains a hole near an edge through which a threaded washer, 50, is placed. A one piece ball-and-stem stem screws into the threaded washer, specifically, by the threaded portion of the stem. The metal ball, 60, fits into a metal socket, 70, attached to a metal pillar. The socket is notched, 80, for the purpose of allowing the stem, when necessary, to gain additional motion in a desired plane with a maximum of 90 degrees of motion in any plane requiring plate tilt. The socket is threaded and receives the ⅝″ metal pillar, 100. Rotation of the plate is theoretically infinite. The socket can be rotated to a desired position which places the notch at the desired location. A locking mechanism, 90, is a modified screw that increases pressure against the ball within the socket by clockwise rotation.

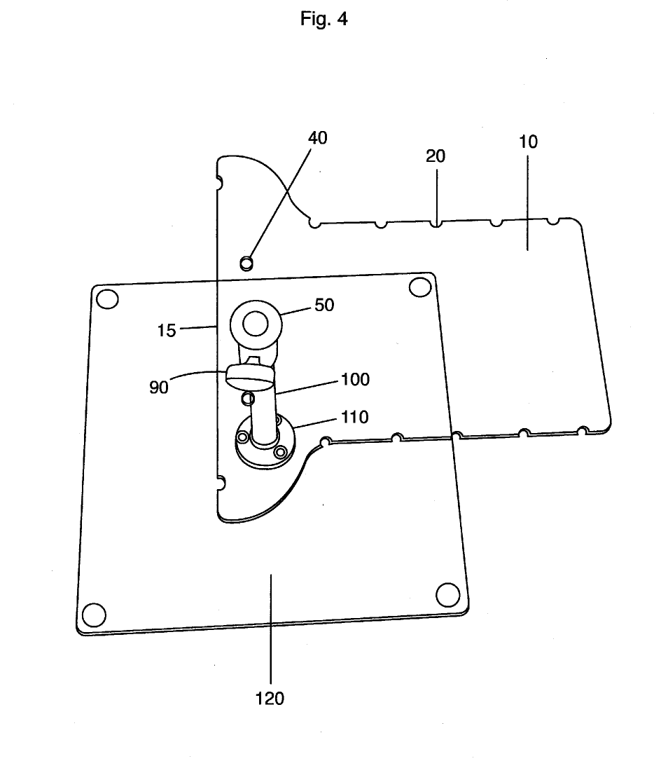

FIG. 4 is a high angle side view of the apparatus with the upper support plate, 10, in neutral position (the upper plate lies parallel to the lower plate). The shape of the upper support plate is seen with a flared proximal end. The upper plate notches, 20, are placed along the sides of the upper support plate. The hole for wrist restraints, 40, lie near the pivotal edge, 15, of the plate. The threaded washer, 50, has a central location along the longitudinal plane of the upper support plate, 10 and is close to the pivotal edge, 15. The surface area of the threaded washer, 50, distributes stress received from the weight of the hand-wrist against the upper support plate, 10, and then transferred to the pivoting mechanism ie the ball and socket assembly. The locking mechanism, 90, provides variable compression electively to the ball that is recessed within the socket. A high angle perspective of the pillar, 100, the pillar support assembly, 110, and the lower support plate are illustrated.

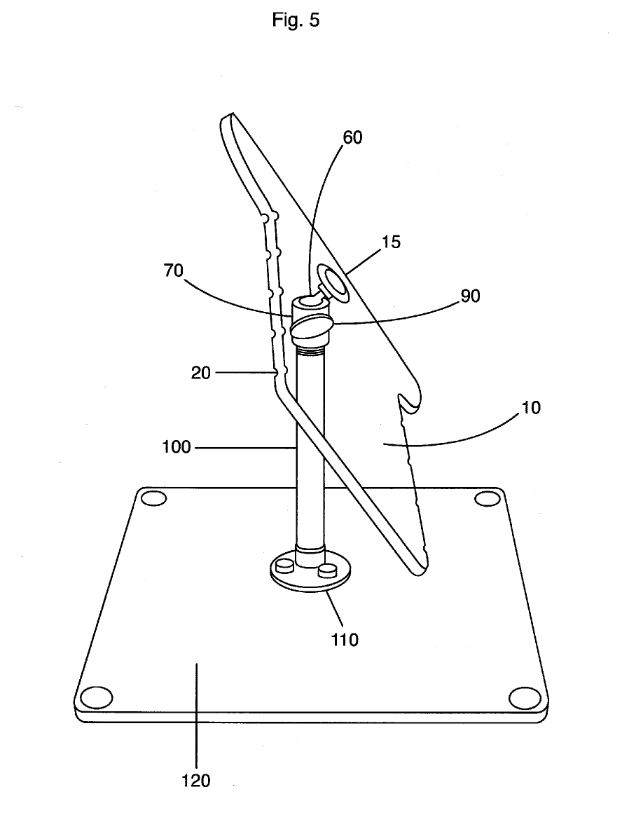

FIG. 5 shows the pivotal edge hand table embodiment from the perspective of the distal edge of the upper support plate, 10, in the foreground. The upper support plate is in a mid-left lateral tilt position which demonstrates the range of motion capabilities of the apparatus. The pivotal edge, 15, is the proximal extent of the plate and in this perspective view appears toward the background. Some estimation of the close proximity of the pivotal edge to the pivoting mechanism (ball and stem, 60) can be appreciated. The ball is seen to lie within the socket, 70. The socket is coupled to the pillar, 100, by threads placed at the end of the pillar. The pillar, pillar support assembly and the lower base support provide load hearing capabilities for the apparatus.

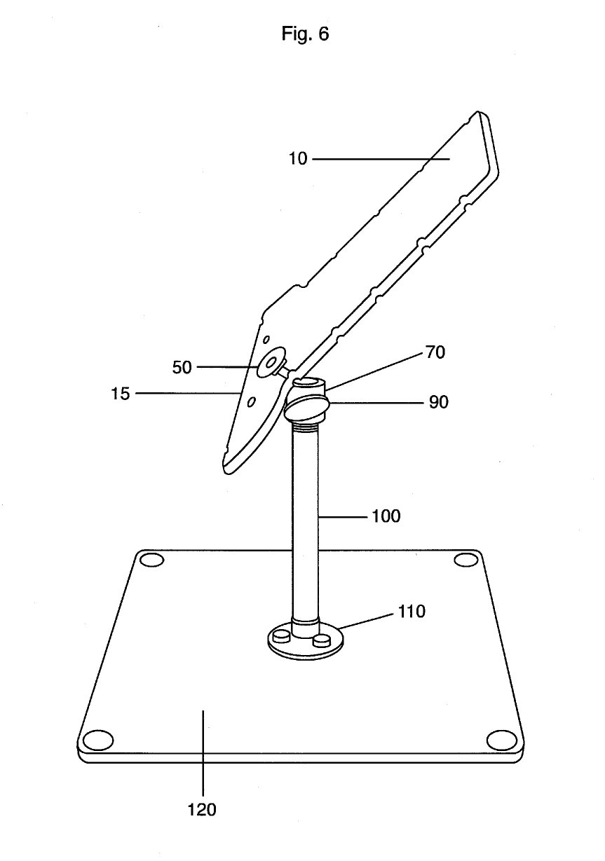

FIG. 6 is a perspective side view of apparatus with the upper plate in a degree of plate-extension. Plate-extension is produced when the midline of the distal plate lies above, ie higher than its position at neutral position. A maximum of almost 90 degrees of plate-extension motion is possible for this embodiment. The upper support plate is depleted as having pivoted from its proximal end. The pivotal edge, 15, lies at the proximal end of the upper support plate. The threaded washer, 50, is placed as close to the pivotal edge as good manufacturing practices will allow for the ¾″ plastic upper support plate and the metal threaded washer. The position of the socket, 70, is shown, as is the knob of the locking mechanism, 90. The socket, pillar, pillar support assembly and lower support plate are attached in series. While this position is given the label of being in plate-extension a backside (dorsum) of hand on the table would place in the hand in a degree of anatomic flexion of the hand relative to the forearm. Similarly, a palm on table position would produce anatomic extension of the hand relative to the forearm. The hand is placed such that the wrist (or junction of the hand to the forearm) lies at the edge of the plate which places the rotational axis of the wrist near the rotational axis of the edge of the table.

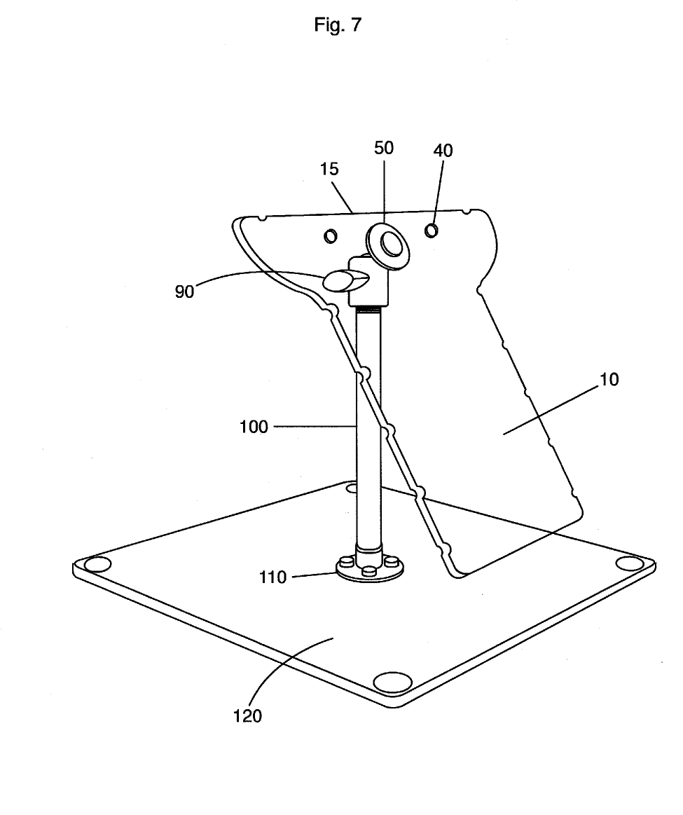

FIG. 7 is a perspective side oblique view of apparatus with the upper support plate, 10, in a degree of plate-flexion. Plate-flexion is produced when the midline of the distal plate lies below, ie lower, than its position in a the neutral position. Proportions of the ball size, the socket, 70, and stem length allow a maximum of almost 90 degrees of plate-flexion for this embodiment. The proximal end of the upper support plate shows positions of the pivotal edge, 15, holes for wrist restraints, 40, and the position of the pivoting mechanism assembly as demonstrated by the position of the threaded washer, 50. A general obliqued perspective view of the upper support plate contouring is again seen. While this position is given the label of being in plate-flexion a backside (dorsum) of hand on the table would place in the hand in a degree of anatomic extension (hand relative to the forearm). Similarly, a palm on table position would produce anatomic flexion of the hand relative to the forearm. The hand is placed such that the wrist (or junction of the hand to the forearm) lies at the edge of the plate which places the rotational axis of the wrist near the rotational axis of the edge of the table.

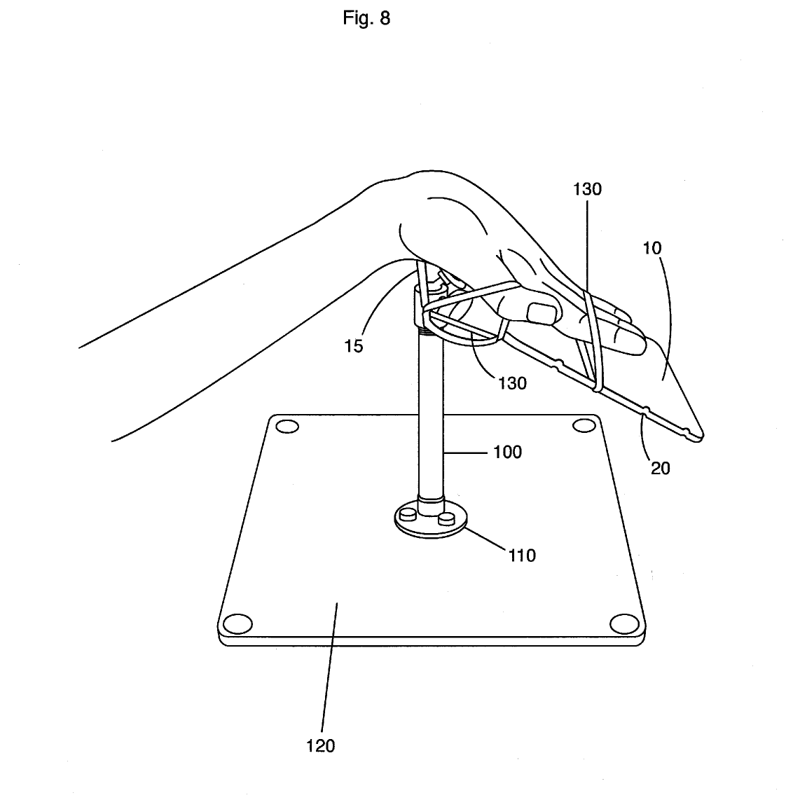

FIG. 8 is a high angle side view of apparatus with a hand resting on the upper support plate, 10, in a degree of plate-flexion (wrist extension) with thumb and digits restrained by ties, 130. This view displays a secured position of the hand and digits with simple string-like ties that anchor through holes and notches provided by the upper support plate. This drawing emphasizes the well positioned hand-wrist having a close relationships of the wrist to the plate edge, 15, and to the pivoting mechanism. The ties that restrain the digits, 130, maintain the hand in substantially the same position throughout upper plate motion. The position as shown would be suitable for many surgical approaches to the carpal tunnel as the relevant operative field is unobstructed. Note that the wrist does not require specific restraints since the weight of the arm pulls it against the device while the digital ties stabilize the hand otherwise to the upper support plate. The pillar, 100, pillar support assembly, 110, and lower support base support the hand-wrist as shown.

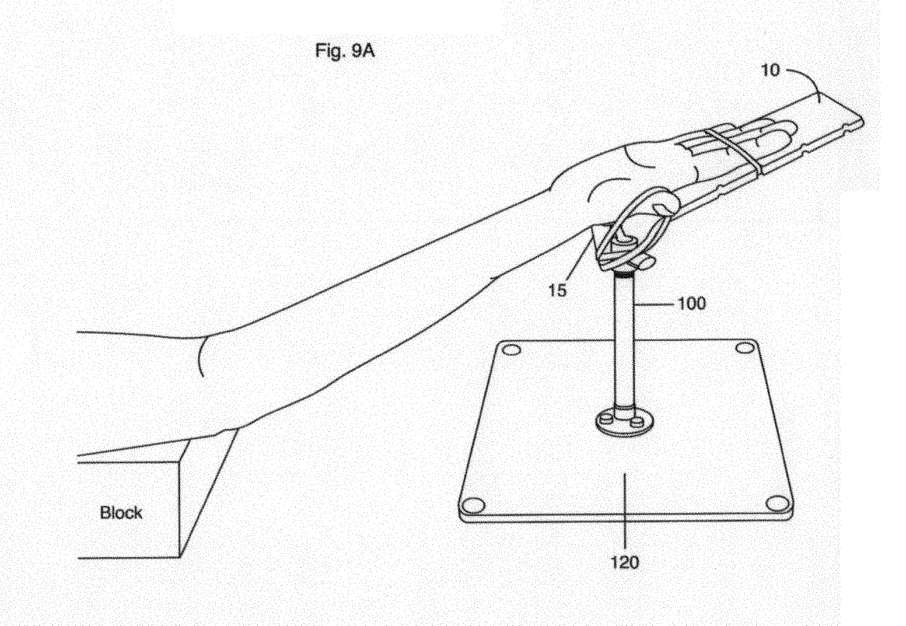

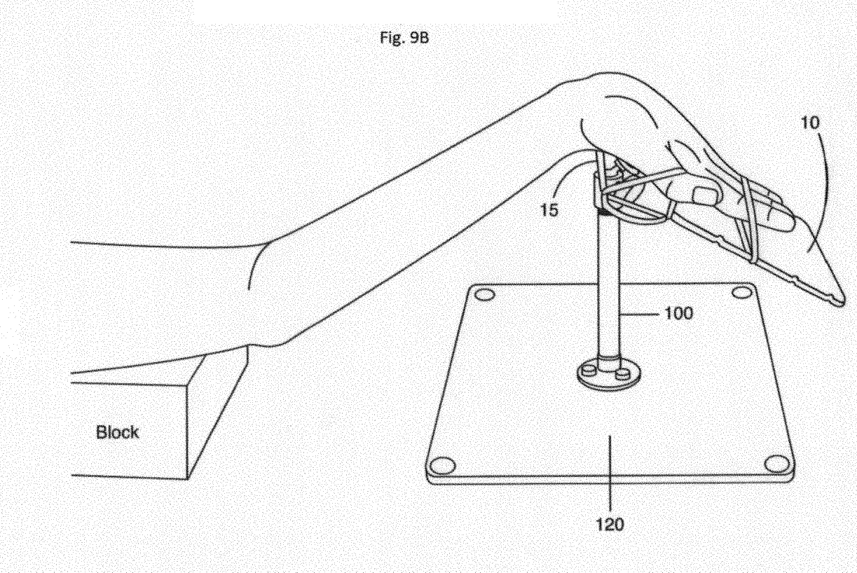

FIG. 9A is a side view of the elbow, forearm and hand positioned on the apparatus in a starting position. The hand lies on the upper support plate, 10, with the pivotal edge, 15, of the table near the wrist. The elbow rests on a standard positioning block which supports the elbow and upper arm. The presented embodiment requires the anatomy proximal to the hand-wrist to be supported such that the angle of the forearm leads to the upper support plate in a manner suitable for a planned procedure. The decision to modify the base for a different embodiment could be based on the frequency of a given procedure where the elbow must be placed in substantially the same position. The hand relative to the forearm lies in about 5 degrees of extension. The upper support plate lies in a degree of plate-extension. The estimated central axis of the wrist lies at the level of the pivotal edge, 15. The upper extremity is further supported by the pillar, 100, and the lower support plate, 120.

FIG. 9B is the same view of the apparatus and the upper extremity as shown in FIG. 9A. The hand lies in substantially the same position (spatial orientation) as the FIG. 9A starting position relative to the upper support plate, but the upper support plate has changed positions ie. to a final position. Through wrist motion, the hand, has been moved to approximately 65 degrees of extension, through plate-flexion, without significant lift or drag of the elbow as demonstrated by the minute transnational change in relationship of the elbow to the support block by a subtle forward translation through soft tissues ie within the elastic limits of the skin, subcutaneous tissue and bursal tissues. General support of the hand by the upper support plate, 15, the pillar, 100, and the lower support plate, 120 are shown.

### Glossary

Action (joint action)—refers to a change in position of a joint by some manner of contortion (ie configuration adjustment of boney alignment of the joint). For example, by motions of the muscles and tendons moving across the wrist or by passive motion by an external force the bones of a normal and otherwise unrestrained wrist will move relative to each other to produce an overall change in wrist configuration which can provide flexion, extension, torsion, radial deviation and ulnar deviation. All of these motions appear to cause movement of the hand. In contrast movements of the hand, especially for smaller movements, can be made by motions of the elbow and shoulder. (See—Movement)

Active motion—is motion produced by the musculature of the structure being moved. The opposite of active motion is passive motion in which motion is produced by external force. Most medical positioning apparatuses are described as functioning by passive movements of the anatomy whereby practitioners place the anatomy without cooperative effort from the patient. The Pivoting Hand Table is frequently used on the awake patient where cooperative effort facilitates the positioning process

Counter—as a noun indicates a flat extended supportive surface such as an operating table arm board. The presented embodiment of the Pivoting Hand Table is portable and must be placed at approximately the same height as the support counter/table of, for example, a supine individual.

Drag—Substantial force required to adjust an extremity during a procedure by pulling the extremity to gain length or to push the extremity for shortening relative to the end of the operating table. Drag is the friction created by this motion.

The Elbow—provides wrist motion by pronation and supination which is allowed by the Pivoting hand table. Flexion-extension actions of the elbow (after initial positioning efforts) are undesirable.

The Hand—lies distill to the wrist. Hand motion on the Pivoting Hand table refers to motion of the restrained metacarpals and secured digits.

Hand motion—movement of the metacarpals through space

Hand-wrist—a term for the hand and the wrist that, from a practical perspective, seem to move as one unit while on the Pivoting Hand Table

Isolated joint movement—active or passive motion of a joint with movement of the distal extremity, but with negligible movement from the anatomy proximal to the joint. For example isolated movement of the normal wrist in all planes produces negligible elbow movement.

Junction of the wrist and the forearm—is an estimate of the location of the central rotational axis of the wrist ie at the capitate. This region is usually lies just beyond (distal to) the most distal bony extent of the forearm.

Orthogonal planes—refers to planes of motion at right angles. For example, the saggittal planes of hand flexion-extension is orthogonal to the coronal supination-pronation plane of the hand. Note that use of the term orthogonal in this case does not provide discrete information on “by what anatomic mechanism or body part” the motion occurs. Pronation-Supination movements of the hand can be produced independently by shoulder action or elbow action, and to a scant degree, wrist motion.

Obligatory movement—intentional or unintentional movement of anatomy from the intentional active or passive positioning of anatomy at a different site. For example, a hand table from the prior art with a centrally placed ball and socket pivoting mechanism can produce obligatory elbow motion when the wrist is moved past 30 degrees of flexion; the elbow must move to accommodate the new position of the hand-wrist.

Lateral Tilt—of the Pivotal hand table accommodates pronation-supination movements of the wrist. The table is viewed from the perspective of the plate edge as being the closest part of the upper support plate to the observer. Left lateral tilt is to the left of an imaginary line bisecting the longitudinal axis of the upper support plate. Right lateral tilt is to the right of the same imaginary line. Whether a hand is pronating or supinating depends upon the direction of motion and the orientation of the hand on the upper support plate, for example, palm-up versus palm-down

Longitudinal Axis—an imaginary plane that runs down the line of the outstretched upper extremity.

Lower support plate—refers to the aggregate of those structures that support the pillars, the upper support plate and a portion of the upper extremity (depending on the desired final position of the upper extremity). The lower support plate may be extended in any direction to accomplish tasks not to exclude providing more secure position of the extremity proximal to the upper support plate, or providing an elevated or lower perch for the upper extremity proximal to the upper support plate. The floor may also function as the lower support plate.

Mediate—A term used in a technical sense to mean “to bring about the physiological effect of”.

Movement (or Motion)—refers to a change in spatial position of an object A change in position of an object (action) should not be confused with movement by the object, for example, a wrist that has a surgical fusion (ie, where the joints cannot move) can be said to have changed positions in space by motions of the elbow. Another example, is if a forearm begins motion parallel to the ground and then is angled 45 degrees by elbow flexion then it can be said that the fused wrist and the hand also moved 45 degrees. Similarly a wrist and hand can change positions substantially on a surgical support device with no actions (see actions definition) by the wrist. The definition of movement is any motion of the wrist (or any anatomic structure) through space

### Motion-See Movement

Near edge—see plate edge, the word “near” refers to an edge of the upper support plate close to the wrist as demonstrated in the ball and socket embodiment of the Pivoting Hand Table

Neutral position—when the position of the upper support plate is parallel to the floor. (see Zero decrees).

Pivotal—a mechanism providing motion and positional options for an object attaching to it not to exclude a simple hinge, a ball-and-socket mechanism or more complex mechanisms where motion of an object can be produced by a mechanism having simultaneous mobile elements.

Pivotal Edge—a proximal edge, rotating edge or near edge of the upper support plate. A central structure for the Pivotal Hand Table concept referring to an imaginary line drawn along the proximal most portion of the plate perpendicular to the longitudinal axis) lying adjacent to the wrist. A perfectly aligned pivotal mechanism produces no vertical or longitudinal change along the pivotal edge with any degree of plate movement (within anatomic limits).

Pivoting Hand table motions—The proximal end off the upper support plate can also be called the near edge ie the edge through which the idealized rotational motion passes. The finger tip side of the upper plate is the distal end. A neutral position is when the plate lies parallel to the ground. If the distal end moves downward this is called “plate-flexion”. Upward motion of the distal end is called plate extension. Lateral tilt of the plate accommodates pronation-supination motion of the hand-wrist. Combinations of lateral tilt, plate flexion, and plate extension provide a wide range of possible positional opportunities for the hand and wrist.

Plate Extension—refers to the distal end of the plate elevating relative to the proximal edge of the plate from a neutral position with the proximal edge of the plate being the support end close to the wrist

Plate Flexion—refers to the distal end of the plate lowering relative to the proximal edge of the plate from a neutral position with the proximal edge of the plate being the support end close to the wrist

Position—the description of an object in 3-dimensional space relative to a qualified reference point For the pivotal edge hand table the reference point is called neutral position. Change in position of an object should not be confused with movement by the object, for example, a wrist that has a surgical fusion (ie, where the joints cannot move) can be said to have changed positions in space by motions of the elbow.

Repositioning—a change of position for the hand-wrist on the pivotal edge hand table wherein the elbow position is fixed. Repositioning of the hand-wrist without the pivotal edge hand table often involves the inefficient task of having to move the elbow which effectively becomes a repositioning of the entire upper extremity

Starting position—also called initial position refers to the point of reference of the upper extremity in space at the beginning of a procedure. This is not to be confused with neutral position (see “neutral position” and “zero degrees”)

Translation—This term refers to the common position of placing an upper extremity on a supportive apparatus with the elbow in contact a supporting surface. There can be motion of the upper extremity with a force applied to the hand which is transmitted along the extremity causing motion of the olecranon by the surrounding elbow anatomy that glides over the relatively loose skin covering the region. A simple illustrative test is for a person to place the tip (olecranon) of the elbow on a hard surface and move the shoulder in small increments; it can be noted that there is movement of the elbow through the elastic surrounding soli tissues to produce about 3 cm of translational movement on average in any direction from the starting point. Once the limit of elasticity is reached the friction (drag) substantially increases making additional positioning of the hand more difficult by the requirement of substantially increased force

Uncoupled Movement—when motion of a joint is performed with negligible contribution from another joint

Upper Arm—referring to an extremity above the condyles of the elbow

Upper Support Plate—A support structure for the wrist and hand

Wrist—The proximal extent lies distal to the end of the radius and the ulna, or to end of whichever of the two (radius or tuna) is more proximal. The distal extent lies at the articulations with: the metacarpals.

Zero (0) degrees—also called “neutral position”. “0 degrees” describes the upper support table in a position parallel to the floor. Descriptions of the angular position of the pivotal edge hand table are in reference to this starting position. Zero degrees is not to be confused with a starting (or initial) position where the angular reference is the surface of the upper plate in neutral position.

I claim:

1. A positioning table for a hand and wrist comprising:
a lower support plate that remains substantially immobile when placed on a surface;
an upper support plate adapted to receive a wrist at an end of the upper support plate, the upper support plate otherwise defining a longitudinal axis for supporting at least a hand;
a pillar coupled to the lower support plate at a first end, and to a means for pivotal movement at a second end;
a means for pivotal movement with one or more moveable elements coupled to the upper support plate whereby said upper support plate pivots from said end of the upper support plate.

2. The lower support plate of claim 1 wherein said lower support plate provides counterbalance for anatomy proximal to the wrist.

3. The upper support plate of claim 1 further shaped to hold a plurality of digital restraint ties that releasably holds the hand and the wrist.

4. The end of upper support plate of claim 1 wherein said end of the upper support plate is sandwiched between the wrist and the means for pivotal movement.

5. The end of the upper support plate of claim 4 wherein the wrist remains secured to said end of the upper support plate by digital restraint ties of the hand on one side and by the weighted dependent position of the more proximal anatomy on the other side.

6. Means for pivotal movement of claim 1 wherein the upper plate tiltably adjusts relative to the lower plate.

7. Means for pivotal movement of claim 6 wherein a stem is coupled to the upper support plate at said end of the upper support plate.

8. Means for pivotal movement of claim 7 wherein compatible detent means are provided to a socket to resist rotation of the upper support plate relative to the lower support plate.

9. Means for pivotal movement of claim 8 further including a ball and stent wherein said stem is threadably received through a hole at said end of the upper supper plate, the ball lying pivotally recessed within a socket coupled to the pillar.

10. A method for positioning a human upper extremity for a hand-wrist procedure comprises the stops of:
providing an apparatus for positioning of a hand-wrist comprising:
a lower support plate that remains substantially immobile when placed on a surface,
an upper support plate adapted to receive a wrist at an end of the upper support plate, the upper support plate otherwise do lining a longitudinal axis for supporting at least a hand,
a pillar coupled to the lower support plate at a first end, and to a means for pivotal movement at a second end,
a means for pivotal movement of the upper support plate provided from said end of the upper support plate such that the upper support plate is tiltably adjustable relative to the lower support plate
placing the apparatus on a counter of sufficient length to accommodate an outstretched position with the pivotal edge toward the shoulder,
placing a human upper extremity on said counter,
lifting the hand-wrist to the device,
placing a wrist over said end of the upper support plate so that the rotational center of said wrist lies over the means for pivotal movement,
securing the hand-wrist and fingers as needed to leave the desired operating field accessible while effectively stabilizing the hand-wrist at the upper support plate,
choosing a proper angle of the forearm relative to the desired wrist position,
supporting and stabilizing that portion of the upper extremity proximal to the apparatus as necessary to counterbalance the apparatus,
rotating the hand-wrist through a range of motion for a planned procedure, whereby wrist action is observed without significant obligators movement of the proximal anatomy.
